(19) United States
(12) Patent Application Publication
(10) Pub. No.: US 2025/0360831 A1
(43) Pub. Date: Nov. 27, 2025

(54) HIGH VOLTAGE CHARGE CONTROL APPARATUS AND METHOD FOR APPLICATION OF NACS

(71) Applicants: Hyundai Motor Company, Seoul (KR); Kia Corporation, Seoul (KR)

(72) Inventor: JinSu Jang, Hwaseong-si (KR)

(21) Appl. No.: 18/885,055

(22) Filed: Sep. 13, 2024

(30) Foreign Application Priority Data
May 22, 2024 (KR) 10-2024-0066194

(51) Int. Cl. B60L 53/66; B60L 53/30

(52) U.S. Cl. CPC B60L 53/66; B60L 53/30

(57) ABSTRACT

A high voltage charge control apparatus for application of NACS may include a charging line extending from a North American Charging Standard (NACS) type inlet, a NACS junction box configured to branch the charging line into a DC charging line and an AC charging line, a high-voltage junction box configured to connect the DC charging line to a high-voltage battery within a vehicle, and an on-board charger configured to connect the AC charging line to the high-voltage battery.

### CROSS-REFERENCE TO RELATED APPLICATIONS

This application claims the benefit of Korean Patent Application No. 10-2024-0066194, filed on May 22, 2024, which application is hereby incorporated herein by reference.

### TECHNICAL FIELD

The present disclosure relates to a high voltage charge control apparatus and method for application of the North American charging standard (NACS).

### BACKGROUND

Currently, electric vehicle charging in North America can be divided into Combined Charging System (CCS) and Tesla methods. CCS supports standards such as SAE J1772, IEC 62196, IEC 61815, and ISO 15118, and enables AC/DC charging based on high-level communication between the vehicle and the charger. In the case of Tesla, it creates and operates its own charging connector and communication specifications and has built its own charging infrastructure such as a supercharger network. Looking at the status of charging infrastructure built in North America as of 2023, it consists of 50% CCS, 30% Tesla, and 20% CHAdeMo.

However, as the Tesla charging method was recently selected as the North American charging standard (NACS), several global automakers, including GM and Ford, announced that they would apply the Tesla charging method (NACS) instead of CCS, and local charging infrastructure companies also plan to supply equipment equipped with the Tesla charging system (NACS), so it is essential to apply the Tesla charging system (NACS) to vehicles sold in North America in the future.

### SUMMARY

The present disclosure relates to a high voltage charge control apparatus and method for application of NACS. More particularly, the present disclosure relate to a high-voltage relay box-based high voltage charge control apparatus and method for application of NACS system.

An embodiment of the present disclosure can provide a high voltage charge control apparatus and method for application of NACS capable of applying the NACS system to North America mass-produced vehicles by adding a separate high-voltage junction box.

An embodiment of the present disclosure can provide a high voltage charge control apparatus and method for application of NACS capable of high-voltage relay control according to determining of AC/DC charging method.

An embodiment of the present disclosure can provide a high voltage charge control apparatus and method for application of NACS capable of being used together with the existing Combined Charging System (CCS) charging.

A high voltage charge control apparatus for application of NACS may include a charging line extending from a North American Charging Standard (NACS) type inlet, a NACS junction box configured to branch the charging line into a DC charging line and an AC charging line, a high-voltage junction box configured to connect the DC charging line to a high-voltage battery within a vehicle, and an on-board charger configured to connect the AC charging line to the high-voltage battery.

The high-voltage junction box and the on-board charger may include at least one switch, respectively, and the at least one switch may be turned on only while the high-voltage battery is charged.

When connecting a charging connector, the on-board charger may turn on a switch when an AC charging is input from the NACS-type inlet, and the high-voltage junction box may turn off the switch when a DC charging is input from the NACS-type inlet.

A high voltage charge control apparatus for application of NACS may further include a vehicle charging communication controller to which a control pilot (CP) line of a NACS charger is connected, where, when a charging connector of the NACS charger is connected to a NACS-type inlet, the vehicle charging communication controller may be configured to sense a CP signal to determine an AC charging or a DC charging.

An inter-charger communication standard protocol supported by the vehicle may be detected, and an AC charging or a DC charging may be determined based on the detected communication standard protocol.

A high voltage charge control apparatus for application of NACS may include a first charging line extending from a NACS-type inlet, a second charging line extending from a CCS-type inlet, a NACS junction box configured to connect the first charging line and the second charging line, and distribute the connected charging line to a DC charging line and an AC charging line, a high-voltage junction box configured to connect the distributed DC charging line to a high-voltage battery within a vehicle, and an on-board charger configured to connect the distributed AC charging line to the high-voltage battery.

The NACS junction box may be configured to branch the first charging line into a first DC charging line and a first AC charging line.

The second charging line may include a second DC charging line and a second AC charging line separated and extending from the CCS-type inlet, respectively, and the NACS junction box may be configured to connect the first DC charging line to the second DC charging line, and connect the first AC charging line to the second AC charging line.

When connecting a charging connector, the on-board charger may turn on a switch when an AC charging is input from the NACS-type inlet or the CCS-type inlet, and the high-voltage junction box may turn off the switch when a DC charging is input from the NACS-type inlet or the CCS-type inlet.

When a charging door of a CCS inlet is opened while charging the high-voltage battery through the NACS-type inlet, the charging may be terminated.

When a charging door of the NACS inlet is opened while charging the high-voltage battery through the CCS-type inlet, the charging may be terminated.

A high voltage charge control method for application of NACS may include detecting a charging connector, sensing a CP signal to determine a communication level when the charging connector is connected, determining a communication standard protocol when the communication level is determined, determining an AC charging or a DC charging based on the determined communication standard protocol, and completing the determined AC charging or the determined DC charging.

The detecting of the charging connector may include determining whether the connection is normal through a control pilot (CP) signal and a proximity detection (PD) signal.

The determining of the communication standard protocol may include determining whether it corresponds to an ISO 15118 standard.

The determining of the AC charging or the DC charging may include determining a charging type as the DC charging, when it does not correspond to the ISO 15118 standard, and determining whether it is the ISO 15118 standard-based AC charging or the ISO 15118 standard-based DC charging, through communication, when it corresponds to the ISO 15118 standard.

A high voltage charge control method for application of NACS may further include branching a charging line extending from a NACS-type inlet into a DC charging line and an AC charging line, by a NACS junction box.

A high voltage charge control method for application of NACS may further include, when a charging type is determined as the DC charging, connecting the DC charging line to a high-voltage junction box, and turning on a switch within the high-voltage junction box.

A high voltage charge control method for application of NACS may further include, when a charging type is determined as the AC charging, connecting the AC charging line to an on-board charger, and turning on a switch within the on-board charger.

The determining the communication standard protocol may include sending standard protocols supported by the vehicle with priority to the charger, when performing high-level communication between a vehicle and a charger, and responding in consideration of the priority of the vehicle, when a coincident protocol exists in comparison to standard protocol supported by the charger.

The detecting the charging connector may include detecting the charging connector connected to a NACS-type inlet or a CCS-type inlet.

A high voltage charge control apparatus and method for application of NACS according to an embodiment may apply the North American Charging Standard (NACS) system to North America mass-produced vehicles by adding a high-voltage junction box, and may enable high-voltage relay control according to determining of AC/DC charging method, such that it may be used together with Combined Charging System (CCS) charging.

### BRIEF DESCRIPTION OF THE DRAWINGS

FIG. 1 is a drawing showing a high-voltage relay box for application of NACS according to an embodiment of the present disclosure.

FIG. 2 is a drawing showing a high-voltage relay box for a combination of CCS and NACS according to an embodiment of the present disclosure.

FIG. 3 is a flowchart showing a high voltage charge control method for application of NACS according to an embodiment of the present disclosure.

FIG. 4 is a flowchart showing a high-voltage relay box-based charge control sequence for NACS system application according to an embodiment of the present disclosure.

FIG. 5 is a signal flowchart showing a signal flow between the charger and the vehicle for standard protocol selection according to an embodiment of the present disclosure.

### DETAILED DESCRIPTION OF ILLUSTRATIVE EMBODIMENTS

Example embodiments of the present disclosure will be described more fully hereinafter with reference to the accompanying drawings such that a person skill in the art may easily implement an embodiment of the present disclosure. As those skilled in the art can realize, the described example embodiments may be modified in various different ways, all without departing from the spirit or scopes of the present disclosure. To clarify the present disclosure, parts that are not related to the description can be omitted, and same elements or equivalents can be referred to with same reference numerals throughout the specification.

In addition, unless explicitly described to the contrary, the word “comprise” and variations such as “comprises” or “comprising” can be understood to imply the inclusion of stated elements but not the exclusion of any other elements. Terms including an ordinary number, such as “first” and “second,” can be used for describing various constituent elements, but the constituent elements are not necessarily limited by such terms. Such terms can be used merely to differentiate one component from other components.

In addition, the terms “unit”, “part” or “portion”, “-er”, and “module” in the specification can refer to a unit that processes at least one function or operation, which may be implemented by hardware, software, or a combination of hardware and software.

Hereinafter, example embodiments of the present disclosure will be described with reference to the drawings.

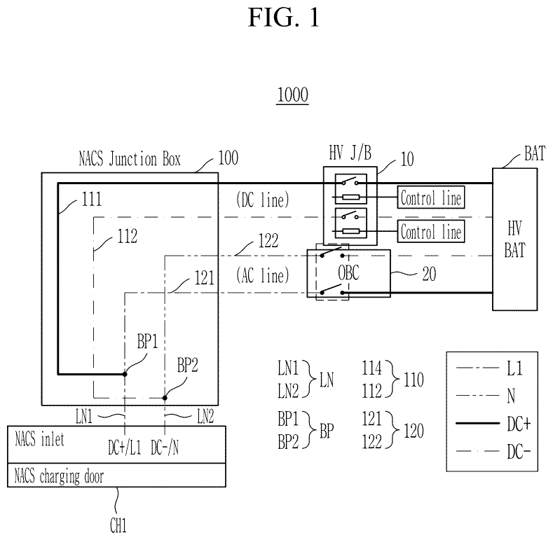

FIG. 1 is a drawing showing a high-voltage relay box for application of NACS according to an embodiment.

A high voltage charge control apparatus 1000 for application of NACS according to an embodiment may include a high-voltage relay box for application of NACS of FIG. 1.

Referring to FIG. 1, the high voltage charge control apparatus 1000 for application of NACS may include a charging line LN, a NACS junction box 100, a high-voltage junction box 10, and an on-board charger 20.

The charging line LN may extend from a North American Charging Standard (NACS) type inlet. The charging line LN may be connected from the NACS-type inlet CH1 installed on a vehicle to a high-voltage battery BAT within the vehicle.

A NACS charging door can be mounted on the NACS inlet CH1. For charging, the NACS charging door may be opened, and a charging connector of the charger may be connected to the NACS inlet CH1, to initiate the charging.

In the case of a NACS-type inlet CH1, the charging line LN may include a first line LN1 commonly used by a DC+ line and an L1 line and a second line LN2 commonly used by a DC− line and a N line.

The NACS junction box 100 may branch the charging line LN into a DC charging line 110 and an AC charging line 120.

The NACS junction box 100 may branch the first line LN1 into a first DC line 111 and a first AC line 121 at a first branch point BP1.

The NACS junction box 100 may branch the second line LN2 into a second DC line 112 and a second AC line 122 at a second branch point BP2.

The DC charging line 110 may include the first DC line 111 branched from the first line LN1 and the second DC line 112 branched from the second line LN2.

The first DC line 111 may be the DC+ line. The second DC line 112 may be the DC− line.

The AC charging line 120 may include the first AC line 121 branched from the first line LN1 and the second AC line 122 branched from the second line LN2.

The first AC line 121 may be the L1 line. The second AC line 122 may be the N line.

The high-voltage junction box 10 may connect the DC charging line 110 extending from the NACS junction box 100 to the high-voltage battery BAT within the vehicle.

The on-board charger 20 may connect the AC charging line 120 extending from the NACS junction box 100 to the high-voltage battery BAT.

The high-voltage junction box 10 and the on-board charger 20 may include at least one switch, respectively. The switch may be a relay switch.

At least one switch of the high-voltage junction box 10 and the on-board charger 20 may be turned on only while the high-voltage battery BAT is charged. The switch may be turned on only while the vehicle is connected to the charger and the battery is being charged, and if not charging, the switch may be turned off by being in an open state.

When connecting a charging connector, and when a DC charging is input from the NACS-type inlet CH1, the high-voltage junction box 10 may turn on a switch within the high-voltage junction box 10.

When connecting a charging connector, and when an AC charging is input from the NACS-type inlet CH1, the on-board charger 20 may turn on a switch within the on-board charger.

The high voltage charge control apparatus 1000 for application of NACS may further include the vehicle charging communication controller to which a control pilot (CP) line of a NACS charger can be connected.

When the charging connector of the NACS charger is connected to the NACS-type inlet CH1, the vehicle charging communication controller may sense a CP signal to determine the AC charging or the DC charging.

The high voltage charge control apparatus 1000 for application of NACS may detect an inter-charger communication standard protocol supported by the vehicle, and may determine the AC charging or the DC charging based on the detected communication standard protocol.

For example, the communication standard protocol may include a DIN 70121 standard, an ISO 15118 standard, or the like.

The high voltage charge control apparatus 1000 for application of NACS may control all switches to an open state when not charging, a switch within the on-board charger 20 may be turned on for the AC charging, and the switch within the high-voltage junction box 10 may be turned on for the DC charging.

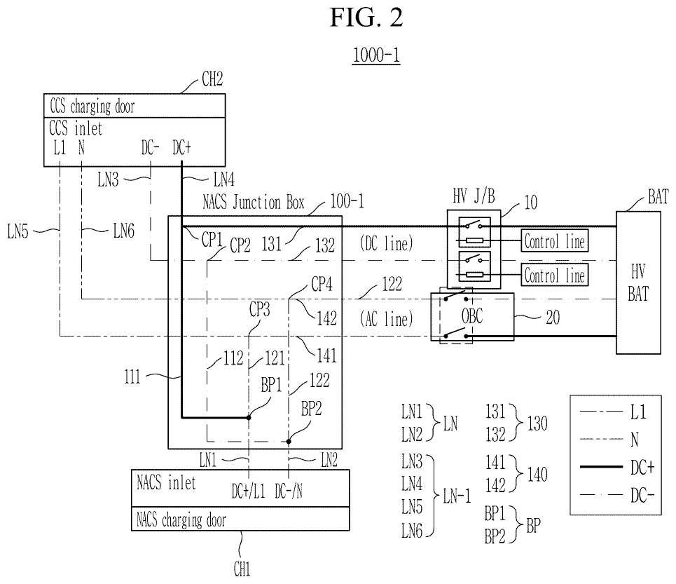

FIG. 2 is a drawing showing the high-voltage relay box for a combination of CCS and NACS according to an embodiment.

The high voltage charge control apparatus 1000 for application of NACS-1 may include the high-voltage relay box for a combination of CCS and NACS of FIG. 2.

Referring to FIG. 2, the high voltage charge control apparatus 1000-1 for application of NACS-1 may include a first charging line LN, a second charging line LN-1, the NACS junction box 100-1, the high-voltage junction box 10, and the on-board charger 20.

The first charging line LN may extend from the North American Charging Standard (NACS)-type inlet CH1.

The second charging line LN-1 may extend from the Combined Charging System (CCS)-type inlet CH2.

The second charging line LN-1 may include second DC charging lines LN3 and LN4 and second AC charging lines LN5 and LN6, separated and extending from the CCS-type inlet CH2, respectively.

The NACS junction box 100-1 may connect the first charging line LN and the second charging line LN-1.

The NACS junction box 100-1 may distribute the connected charging line to which the first charging line LN and the second charging line LN-1 are connected to the connected DC charging line 130 and the connected AC charging line 140.

The NACS junction box 100-1 may branch the first charging line LN into first DC charging lines 111 and 112 and first AC charging lines 121 and 122.

The NACS junction box 100-1 may connect the first DC charging lines 111 and 112 to the second DC charging lines LN3 and LN4, and may connect the first AC charging lines 121 and 122 to the second AC charging lines LN5 and LN6.

The first DC charging lines 111 and 112 may include the first DC line 111 and the second DC line 112. The first AC charging lines 121 and 122 may include the first AC line 121 and the second AC line 122.

The second DC charging lines LN3 and LN4 may include a third DC line LN3 and a fourth DC line LN4. The second AC charging lines LN5 and LN6 may include a third AC line LN5 and a fourth AC line LN6.

The NACS junction box 100-1 may connect the first DC line 111 to the third DC line LN3 at a first connection point CP1.

The NACS junction box 100-1 may connect the second DC line 112 to the fourth DC line LN4 at a second connection point CP2.

The NACS junction box 100-1 may connect the first AC line 121 to the third AC line LN5 at a third connection point CP3.

The NACS junction box 100-1 may connect the second AC line 122 to the fourth AC line LN6 at a fourth connection point CP4.

The NACS junction box 100-1 may distribute the connected DC charging line 130 and the connected AC charging line 140.

The high-voltage junction box 10 may connect the distributed and the connected DC charging line 130 to the high-voltage battery BAT within the vehicle.

The on-board charger 20 may connect the distributed and connected AC charging line 140 to the high-voltage battery BAT.

When the AC charging is input from the NACS-type inlet CH1 or the CCS-type inlet CH2, the on-board charger 20 may turn on the switch within the on-board charger 20.

When the DC charging is input from the NACS-type inlet CH1 or the CCS-type inlet CH2, the high-voltage junction box 10 may turn on the switch within the high-voltage junction box 10.

When a charging door of a CCS inlet CH2 is opened while charging the high-voltage battery BAT through the NACS-type inlet CH1, the high voltage charge control apparatus 1000 for application of NACS-1 may terminate the charging.

When charging door of the NACS inlet CH1 is opened while charging the high-voltage battery BAT through the CCS-type inlet CH2, the high voltage charge control apparatus 1000 for application of NACS-1 may terminate the ongoing charging.

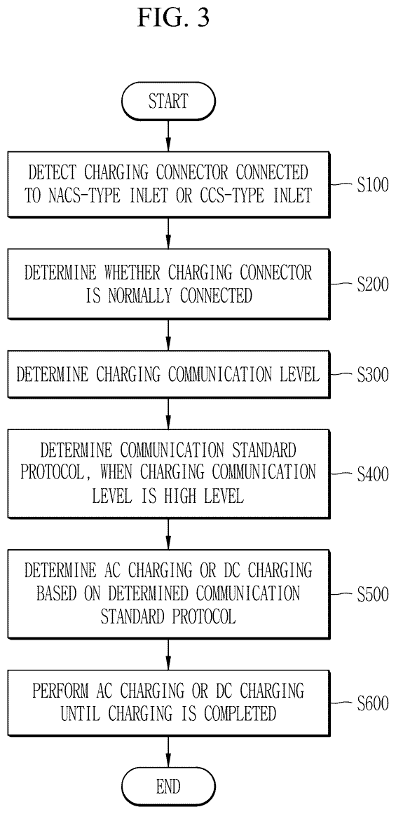

FIG. 3 is a flowchart showing a high voltage charge control method for application of NACS according to an embodiment. A high voltage charge control method for application of NACS may be performed through the high voltage charge control apparatuses 1000 and 1000-1 for application of NACS of FIG. 1 and FIG. 2.

In FIG. 3, at step S100, the high voltage charge control apparatuses 1000 and 1000-1 for application of NACS may detect the charging connector.

When the charging connector from the charger is connected to the NACS-type inlet or the CCS-type inlet, the high voltage charge control apparatuses 1000 and 1000-1 for application of NACS may detect that.

At step S200, the high voltage charge control apparatuses 1000 and 1000-1 for application of NACS may determine whether the charging connector is normally connected.

At step S300, the high voltage charge control apparatuses 1000 and 1000-1 for application of NACS may determine a charging communication level.

At step S400, when the charging communication level is the high level, the high voltage charge control apparatuses 1000 and 1000-1 for application of NACS may determine the communication standard protocol.

The high voltage charge control apparatuses 1000 and 1000-1 for application of NACS may determine whether the communication protocol that is supported or is being used is the DIN 70121 and/or the ISO 15118.

At step S500, the high voltage charge control apparatuses 1000 and 1000-1 for application of NACS may determine whether it is the AC charging or the DC charging based on the determined communication standard protocol.

At step S600, the high voltage charge control apparatuses 1000 and 1000-1 for application of NACS may perform the AC charging or the DC charging until the charging is completed.

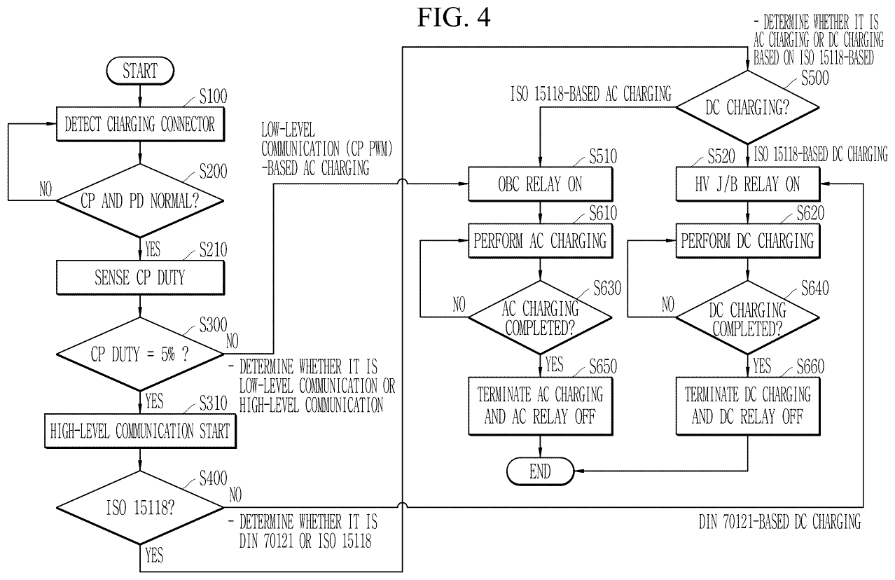

FIG. 4 is a flowchart showing the high-voltage relay box-based charge control sequence for NACS system application according to an embodiment.

The high-voltage relay box-based charge control sequence for application of NACS system of FIG. 4 may be performed through the high voltage charge control apparatuses 1000 and 1000-1 for application of NACS. FIG. 4 specifically represents the embodiment of FIG. 3.

In FIG. 4, at step S100, the high voltage charge control apparatuses 1000 and 1000-1 for application of NACS may detect the charging connector connected from the charger to the NACS-type inlet or the CCS-type inlet.

At step S200, the high voltage charge control apparatuses 1000 and 1000-1 for application of NACS may determine whether the connection is normal through a control pilot (CP) signal and/or a proximity detection (PD) signal.

The CP signal may be received from the CP line for exchanging information between the charger and the vehicle, and the PD signal may be received from the PD line for detecting whether the charging connector is well connected.

For example, the CP signal can be sent from the charger (i.e., electric vehicle supply equipment (EVSE)) in the waveform of ±12V and 1 kHz PWM waveform.

When the CP signal and the PD signal are determined to be normal, the high voltage charge control apparatuses 1000 and 1000-1 for application of NACS may determine the connection to be normal.

When the connection is determined not to be normal, the high voltage charge control apparatuses 1000 and 1000-1 for application of NACS may retry the detection of the charging connector.

At step S210, when the connection is determined to be normal, the high voltage charge control apparatuses 1000 and 1000-1 for application of NACS may sense CP Duty.

The PWM duty ratio of the CP contains information on the current limit capacity that can be supplied from the charger. A CP duty ratio may be determined by the current limit of the charger or the charge stand. The CP duty may be expressed as a percentage value corresponding to the maximum current.

In the ISO 15118, the CP Duty may be fixed to 5%, and the CP Duty of 5% may be output from the charger (EVSE). The charger may output pwm output by using a 12V voltage source.

When the charging connector is connected, the charger can output 12v pwm output of 5% CP Duty.

At step S300, the high voltage charge control apparatuses 1000 and 1000-1 for application of NACS may determine whether the sensed CP duty is 5%.

At step S310, when the CP duty is 5%, the high voltage charge control apparatuses 1000 and 1000-1 for application of NACS may start high-level communication.

When the CP duty is not 5%, the high voltage charge control apparatuses 1000 and 1000-1 for application of NACS may perform a low-level communication (CP PWM)-based AC charging.

At step S510, the high voltage charge control apparatuses 1000 and 1000-1 for application of NACS may turn on the relay switch of on-board charger (OBC) for the low-level communication (CP PWM)-based AC charging.

When the high-level communication is started, the high voltage charge control apparatuses 1000 and 1000-1 for application of NACS may determine the communication standard protocol. For example, at step S400, the high voltage charge control apparatuses 1000 and 1000-1 for application of NACS may determine whether the charger and the communication protocol support the ISO 15118 standard.

When performing the high-level communication between the vehicle and the charger, the high voltage charge control apparatuses 1000 and 1000-1 for application of NACS send standard protocols supported by the vehicle to the charger, by setting priority.

When a coincident protocol exists in comparison with the standard protocol supported by the charger, the high voltage charge control apparatuses 1000 and 1000-1 for application of NACS may respond in consideration of the priority of the vehicle.

At step S520, when it does not correspond to the ISO 15118 standard, the high voltage charge control apparatuses 1000 and 1000-1 for application of NACS may determine a charging type as the DC charging, and may turn on a relay switch of the high-voltage junction box HV J/B.

For example, when it is determined as the DIN 70121 standard, the high voltage charge control apparatuses 1000 and 1000-1 for application of NACS may turn on the relay switch of the high-voltage junction box for the DIN 70121-based DC charging.

When performing the DC charging, the input side of the on-board charger must satisfy the withstand voltage specification.

A relay capacity may be selected according to the charging system capacity within the vehicle.

At step S500, when it corresponds to the ISO 15118 standard, the high voltage charge control apparatuses 1000 and 1000-1 for application of NACS may determine whether it is the ISO 15118 standard-based AC charging or the DC charging through communication.

At step S510, in the case of the ISO 15118-based AC charging, the high voltage charge control apparatuses 1000 and 1000-1 for application of NACS may turn on the relay switch of the on-board charger.

At step S520, in the case of the ISO 15118-based DC charging, the high voltage charge control apparatuses 1000 and 1000-1 for application of NACS may turn on the relay switch of the high-voltage junction box.

In an embodiment, the high voltage charge control apparatuses 1000 and 1000-1 for application of NACS may branch the charging line extending from the NACS-type inlet into the DC charging line and the AC charging line through the NACS junction boxes 100 and 100-1 (see FIG. 1 and FIG. 2).

When the charging type is determined as the DC charging, the high voltage charge control apparatuses 1000 and 1000-1 for application of NACS may connect the DC charging line to the high-voltage junction box, and may turn on the switch within the high-voltage junction box.

When the charging type is determined as the AC charging, the high voltage charge control apparatuses 1000 and 1000-1 for application of NACS may connect the AC charging line to the on-board charger, and may turn on the switch within the on-board charger.

At step S610, when the switch of the on-board charger is turned on, the high voltage charge control apparatuses 1000 and 1000-1 for application of NACS may perform the AC charging.

The high voltage charge control apparatuses 1000 and 1000-1 for application of NACS determines whether the AC charging is completed at step S630, and when it is determined that the charging is completed, it may terminate the AC charging and turn off the switch of the on-board charger at step S650.

At step S620, when the switch of the high-voltage junction box is turned on, the high voltage charge control apparatuses 1000 and 1000-1 for application of NACS may perform the DC charging.

The high voltage charge control apparatuses 1000 and 1000-1 for application of NACS may determine whether the DC charging is completed at step S640, and when it is determined that the charging is completed, it may terminate the DC charging and turn off the switch of the high-voltage junction box at step S660.

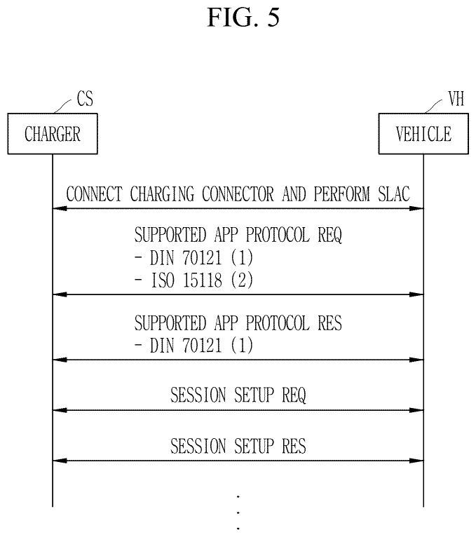

FIG. 5 is a signal flowchart showing a signal flow between the charger and the vehicle for standard protocol selection according to an embodiment.

When performing the high-level communication between a vehicle VH and a charger CS, the high voltage charge control apparatuses 1000 and 1000-1 for application of NACS may communicate according to the DIN 70121 or the ISO 15118.

When standard protocols supported by the vehicle VH by setting priority are sent in the step of transmitting/receiving Supported App Protocol message, the high voltage charge control apparatuses 1000 and 1000-1 for application of NACS may respond in consideration of the priority of the vehicle VH, when a coincident protocol exists in comparison with the standard protocol supported by the corresponding charger CS.

Standards reference herein encompass any standard compatible with a standard released on or before the effective filing date of this patent.

While this disclosure has been described in connection with what is presently considered to be practical example embodiments, it can be understood that the disclosure is not necessarily limited to the disclosed embodiments, but, on the contrary, is intended to cover various modifications and equivalent arrangements included within the spirit and scopes of the appended claims.

What is claimed is:

1. A high voltage charge control apparatus for application of a North American Charging Standard (NACS), comprising:
a charging line extending from a NACS type inlet;
a NACS junction box configured to branch the charging line into a DC charging line and an AC charging line;
a high-voltage junction box configured to connect the DC charging line to a high-voltage battery within a vehicle; and
an on-board charger configured to connect the AC charging line to the high-voltage battery.

2. The apparatus of claim 1, wherein each of the high-voltage junction box and the on-board charger comprise at least one switch, respectively, and each of the high-voltage junction box and the on-board charger being configured such that the at least one switch is turned on only while the high-voltage battery is charged.

3. The apparatus of claim 1, wherein, in response to connecting a charging connector:
the on-board charger is configured to turn on a switch in response to an AC charging being input from the NACS type inlet; and
the high-voltage junction box is configured to turn off the switch in response to a DC charging being input from the NACS type inlet.

4. The apparatus of claim 1, further comprising a vehicle charging communication controller to which a control pilot (CP) line of a NACS charger is connected,
wherein, in response to a charging connector of the NACS charger being connected to a NACS-type inlet, the vehicle charging communication controller is configured to sense a CP signal to determine an AC charging or a DC charging.

5. The apparatus of claim 1 being configured to detect an inter-charger communication standard protocol supported by the vehicle, and being configured to determine an AC charging or a DC charging based on the detected communication standard protocol.

6. A high voltage charge control apparatus, comprising:
a first charging line extending from a NACS-type inlet, where NACS covers a North American Charging Standard;
a second charging line extending from a CCS-type inlet, where CCS covers a Combined Charging System;
a NACS junction box configured to connect the first charging line and the second charging line, and distribute the connected charging line to a DC charging line and an AC charging line;
a high-voltage junction box configured to connect the distributed DC charging line to a high-voltage battery within a vehicle; and
an on-board charger configured to connect the distributed AC charging line to the high-voltage battery.

7. The apparatus of claim 6, wherein the NACS junction box is configured to branch the first charging line into a first DC charging line and a first AC charging line.

8. The apparatus of claim 7, wherein:
the second charging line comprises a second DC charging line and a second AC charging line separated and extending from the CCS-type inlet, respectively; and
the NACS junction box is configured to connect the first DC charging line to the second DC charging line, and connect the first AC charging line to the second AC charging line.

9. The apparatus of claim 6, wherein, when connecting a charging connector:
the on-board charger turns on a switch when an AC charging is input from the NACS-type inlet or the CCS-type inlet; and
the high-voltage junction box turns off the switch when a DC charging is input from the NACS-type inlet or the CCS-type inlet.

10. The apparatus of claim 6, wherein, when charging door of a CCS inlet is opened while charging the high-voltage battery through the NACS-type inlet, the charging is terminated.

11. The apparatus of claim 6, wherein, when charging door of the NACS inlet is opened while charging the high-voltage battery through the CCS-type inlet, the charging is terminated.

12. A high voltage charge control method for application of a North American Charging Standard (NACS), the method comprising:
detecting a charging connector;
sensing a control pilot (CP) signal to determine a communication level in response to the charging connector being connected;
determining a communication standard protocol in response to the communication level being determined;
determining an AC charging or a DC charging based on the determined communication standard protocol; and
completing the determined AC charging or the determined DC charging.

13. The method of claim 12, wherein the detecting of the charging connector comprises determining whether the connection is matching one of a set of charging standard protocols, through the CP signal and a proximity detection (PD) signal.

14. The method of claim 12, wherein determining the communication standard protocol comprises determining whether it corresponds to an ISO 15118 standard.

15. The method of claim 14, wherein the determining the AC charging or the DC charging comprises:
determining a charging type as the DC charging, in response to the determined communication standard protocol not corresponding to the ISO 15118 standard; and
determining whether the charging type is ISO 15118 standard-based AC charging or ISO 15118 standard-based DC charging, through communication, in response to the determined communication standard protocol corresponding to the ISO 15118 standard.

16. The method of claim 12, further comprising branching a charging line extending from a NACS-type inlet into a DC charging line and an AC charging line, by a NACS junction box.

17. The method of claim 16, further comprising, in response to a charging type being determined as the DC charging, connecting the DC charging line to a high-voltage junction box, and turning on a switch within the high-voltage junction box.

18. The method of claim 16, further comprising, in response to a charging type being determined as the AC charging, connecting the AC charging line to an on-board charger, and turning on a switch within the on-board charger.

19. The method of claim 12, wherein determining of the communication standard protocol comprises:
sending standard protocols supported by a vehicle with priority to a charger, in response to performing high-level communication between a vehicle and a charger; and
responding in consideration of the priority of the vehicle, in response to a coincident protocol existing in comparison to standard protocol supported by the charger.

20. The method of claim 12, wherein the detecting of the charging connector comprises detecting the charging connector connected to a NACS-type inlet or a CCS-type inlet.
